(19) United States
(12) Patent Application Publication
(10) Pub. No.: US 2014/0305852 A1
(43) Pub. Date: Oct. 16, 2014

(54) ANAEROBIC TREATMENT SYSTEM AND ANAEROBIC TREATMENT METHOD

(71) Applicant: Sumitomo Heavy Industries, Ltd., Tokyo (JP)

(72) Inventor: Noriyuki Fujimoto, Kanagawa (JP)

(73) Assignee: SUMITOMO HEAVY INDUSTRIES, LTD., Tokyo (JP)

(21) Appl. No.: 14/250,723

(22) Filed: Apr. 11, 2014

(30) Foreign Application Priority Data
Apr. 15, 2013 (JP) 2013-084766

(51) Int. Cl. C02F 3/28

(52) U.S. Cl. CPC C02F 3/28
USPC 210/96.1

(57) ABSTRACT

Provided is an anaerobic treatment system including an anaerobic treatment tank that anaerobically treats organic waste water by sludge which is acclimated to a low temperature condition, a state evaluation unit that evaluates a state of the organic waste water with respect to the anaerobic treatment tank, and a heating unit that heats the organic waste water which flows into the anaerobic treatment tank, in which when the state evaluation unit determines that heating is necessary, a temperature of the organic waste water is increased by the heating unit.

### INCORPORATION BY REFERENCE

Priority is claimed to Japanese Patent Application No. 2013-084766, filed Apr. 15, 2013, the entire content of each of which is incorporated herein by reference.

### BACKGROUND

1. Technical Field

The present invention relates to an anaerobic treatment system and an anaerobic treatment method.

2. Description of the Related Art

In the related art, an anaerobic treatment system and an anaerobic treatment method that obtain treated water from anaerobically treating organic waste water including an organic component, has been known. The anaerobic treatment system obtains the treated water of which a concentration of an organic material is decreased, by decomposing the organic material through performing a methane fermentation treatment in an anaerobic treatment tank after introducing the organic waste water into a pretreatment tank and performing a pretreatment.

### SUMMARY

According to an embodiment of the present invention, there is provided an anaerobic treatment system including an anaerobic treatment tank that anaerobically treats organic waste water by sludge which is acclimated to a low temperature condition, a state evaluation unit that evaluates a state of the organic waste water with respect to the anaerobic treatment tank, and a heating unit that heats the organic waste water which flows into the anaerobic treatment tank, in which when the state evaluation unit determines that heating is necessary, a temperature of the organic waste water is increased by the heating unit.

According to another embodiment of the present invention, there is provided an anaerobic treatment method including anaerobically treating organic waste water by sludge which is acclimated to a low temperature condition in an anaerobic treatment tank, evaluating a state of the organic waste water with respect to the anaerobic treatment tank, and heating the organic waste water which flows into the anaerobic treatment tank, in which when that heating is necessary is determined in the evaluating, a temperature of the organic waste water is increased in the heating.

### BRIEF DESCRIPTION OF THE DRAWINGS

FIG. 1 is a schematic diagram illustrating a configuration of an anaerobic treatment system according to an embodiment of the present invention.

FIG. 2 is a flowchart illustrating an example of a flow of a control treatment by a control unit.

FIG. 3 is a graph illustrating an example of a fluctuation in a load and a temperature of organic waste water.

### DETAILED DESCRIPTION

Here, in the anaerobic treatment system of the related art that anaerobically treats the organic waste water, an anaerobic treatment has been performed by controlling the temperature to an intermediate temperature condition (for example, 30° C. to 40° C.) or a high temperature condition (for example, 50° C. to 60° C.) of an optimum temperature of an anaerobic bacterium in the sludge. For example, since the organic waste water such as normal industrial waste water has a low temperature of 10° C. to 20° C., the anaerobic treatment has been performed by heating the organic waste water. On the other hand, the treatment (for example, non-heating methane fermentation waste water treatment) is also performed so as to reduce energy by performing the anaerobic treatment on the low temperature condition. However, since the anaerobic treatment in the low temperature condition is easy to be influenced by a change (for example, a load fluctuation) of a state of the organic waste water, the treatment may not correspond to the change (for example, a rapid increase of the load) of the state. Therefore, there is a need for the anaerobic treatment system and the anaerobic treatment method that can correspond to the change of the state of the organic waste water while being able to reduce the energy.

According to an embodiment of the present invention, there is provided an anaerobic treatment system and an anaerobic treatment method that are able to correspond to a change of a state of organic waste water while being able to reduce energy.

According to the embodiment of the present invention, the anaerobic treatment system includes the anaerobic treatment tank that anaerobically treats the organic waste water by the sludge which is acclimated to the low temperature condition. Therefore, when the state of the organic waste water is stable (for example, when the load is stable), it is possible to treat the organic waste water on the low temperature condition. Thereby, it is possible to reduce the energy. On the other hand, when the state evaluation unit determines that heating is necessary, the anaerobic treatment system can increase the temperature of the organic waste water by the heating unit. In the sludge which is acclimated to the low temperature condition, if the temperature is temporarily increased, activity is temporarily increased. Accordingly, when heating is necessary (for example, when the load of the organic waste water is increased), the temperature of the organic waste water is increased by the heating unit, and then, the activity temporarily is increased. Thereby, even when the state is changed (for example, when the load is rapidly increased), the stable treatment can be performed. By the above, it is possible to correspond to the change of the state of the organic waste water while being able to reduce the energy.

According to the embodiment of the present invention, the anaerobic treatment system may further include a recovery unit that recovers biogas which is generated in the anaerobic treatment tank, in which the state evaluation unit may perform evaluation based on an amount of the biogas which is recovered by the recovery unit. Since the generated amount of the biogas is increased or decreased depending on the fluctuation of the load in the organic waste water, the state evaluation unit may evaluate the state of the organic waste water based on the amount of the biogas. Thereby, it is possible to exclude a configuration for directly measuring the state of the organic waste water.

According to another embodiment of the present invention, the anaerobic treatment method includes anaerobically treating the organic waste water by the sludge which is acclimated to the low temperature condition in the anaerobic treatment tank. Therefore, when the state of the organic waste water is stable (for example, when the load is stable), it is possible to treat the organic waste water on the low temperature condition. Thereby, it is possible to reduce the energy. On the other hand, when that heating is necessary is determined in the evaluating, the anaerobic treatment method can increase the temperature of the organic waste water in the heating. In the sludge which is acclimated to the low temperature condition, if the temperature is temporarily increased, the activity is temporarily increased. Accordingly, when heating is necessary (for example, when the load of the organic waste water is increased), the temperature of the organic waste water is increased in the heating, and then, the activity temporarily is increased. Thereby, even when the state is changed (for example, when the load is rapidly increased), the stable treatment can be performed. By the above, it is possible to correspond to the change of the state of the organic waste water while being able to reduce the energy.

Hereinafter, exemplary embodiments of the present invention will be described with reference to drawings. Furthermore, in the following description, the same reference numerals are used to the same components, and the repeated description is excluded.

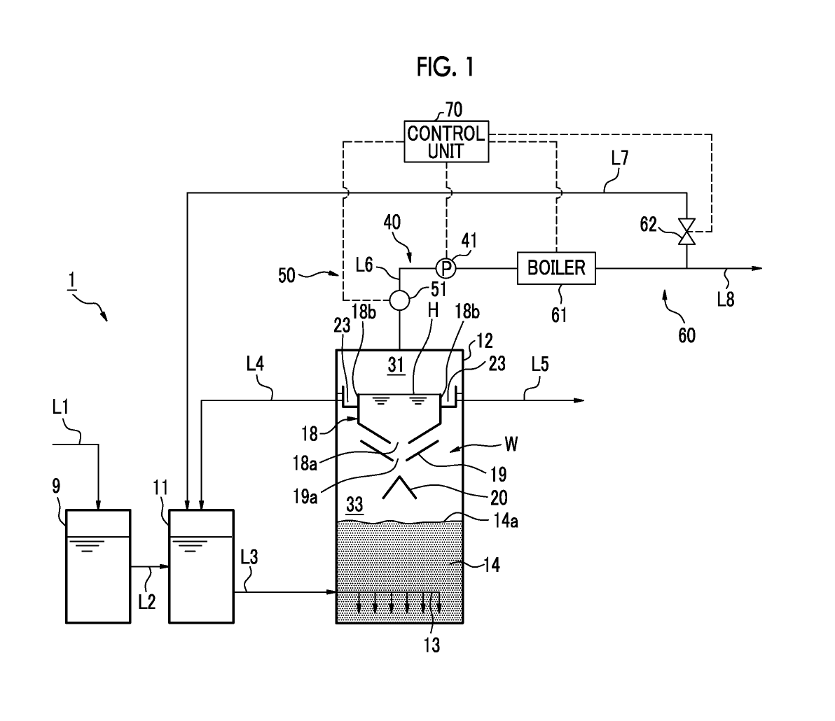

FIG. 1 is a schematic diagram illustrating a configuration of an anaerobic treatment system according to an embodiment of the present invention. An anaerobic treatment system 1 includes a regulating tank 9 that receives organic waste water W which is passed through a raw water inflow pipe L1, an acid generating tank 11 which is arranged in a subsequent stage, and an anaerobic treatment tank 12 which is arranged in the further subsequent stage.

The regulating tank 9 is the tank which performs the treatment for regulating a flow rate of the organic wastewater W which is sent out to the subsequent stage. From the regulating tank 9, the organic waste water W is sent at a predetermined flow rate to the acid generating tank 11 through a water pipe L2. The acid generating tank 11 decomposes an organic material which is included in the organic waste water W into acetic acid or the like by an acid generating bacterium. Moreover, an alkaline agent (for example, sodium hydroxide) as a neutralizing agent can be added to the acid generating tank 11. The acid generating tank 11 is connected to a water pipe L3, and the organic waste water W in the acid generating tank 11 flows into the anaerobic treatment tank 12 of an upflow type by a pump which is arranged in the water pipe L3.

The anaerobic treatment tank 12 is the water treatment tank of the type referred to as a UASB (UpflowAnaerobic Sludge Blanket) reactor or the like which is configured of a container having a rectangular parallelepiped shape. In a lower portion of the anaerobic treatment tank 12, an inflow unit 13 is arranged. The inflow unit 13 comes in contact with the water pipe L3, and makes the organic waste water W flow into the anaerobic treatment tank 12. For example, the inflow unit 13 is the water pipe in which hole units are uniformly arranged in a longitudinal direction. In the anaerobic treatment tank 12, the granular sludge which is configured by granulating the anaerobic sludge is stored. The organic waste water W comes in contact with granular sludge. Thereby, the organic waste water W is anaerobically treated by the anaerobic bacterium in the granular sludge. The granular sludge is precipitated and accumulated in the lower portion in the organic waste water W, and thus, a granular sludge layer 14 is formed in the lower portion of the anaerobic treatment tank 12.

In the anaerobic treatment tank 12, an upward flow occurs by introducing the organic waste water W thereinside from the inflow unit 13 which is arranged in the lower portion thereof, and thus, the organic waste water W is anaerobically treated by passing the organic waste water W through the granular sludge layer 14. In an upper portion of the granular sludge layer 14, a liquid layer of the organic waste water W which is anaerobically treated by passing through the granular sludge layer 14, is formed. In the liquid layer of the organic waste water W, the biogas (for example, methane gas) which is generated by the anaerobic treatment and the granular sludge which is rolled up along with the increase of the biogas, are included.

Furthermore, in the upper portion of the anaerobic treatment tank 12, a three phase separation unit 18 for separating the organic waste water W and the granular sludge and the biogas, is arranged. The three phase separation unit 18 can separate granules even when the floating granules are present in the liquid layer of the organic waste water W. Moreover, the floating granular sludge is the granular sludge that floats, for example, the granular sludge to which the gas is attached, or the granular sludge in which the gas is contained.

In a lower end portion of the three phase separation unit 18, an introduction port 18a that introduces the organic waste water W inside the three phase separation unit 18, is formed. In order to guide the organic waste water W to the introduction port 18a, an introduction plate 19 which is placed along a bottom portion of the three phase separation unit 18, is arranged on the periphery of the introduction port 18a which is a lower side of the three phase separation unit 18. Furthermore, in the introduction plate 19, a return port 19a for returning the organic waste water W which is not introduced into the introduction port 18a to the lower side, is formed. In addition, on the further lower side of the introduction plate 19, a straightening plate 20 for preventing the biogas from introducing into the three phase separation unit 18 through the return port 19a and the introduction port 18a, is arranged.

The organic waste water W passes through the granular sludge layer 14, moves upward and flows into an introduction path which is formed between the introduction plate 19 and the three phase separation unit 18 by the introduction plate 19 from outside. Part of the organic waste water W which is passed through the introduction path flows into the three phase separation unit 18 from the introduction port 18a, and the other part thereof is made so as to flow to the lower side from the return port 19a of the introduction plate 19.

The organic waste water W which flows into the three phase separation unit 18 overflows outside from a side wall 18b of the three phase separation unit 18, and is collected in a treated water discharge unit 23 as a treated water. According to a height of an upper end of the side wall 18b, a liquid face H of the organic waste water W is formed. Part of the treated water in the treated water discharge unit 23 is returned to the acid generating tank 11 through a treated water return path L4, and the remained part of the treated water in the treated water discharge unit 23 is discharged outside the system through a drain pipe L5. In the three phase separation unit 18, a baffle plates for preventing a foreign material from outflowing may be arranged inside the side wall 18b of the three phase separation unit 18. Accordingly, it is possible to prevent an outflow of the foreign material.

In addition, within the anaerobic treatment tank 12, the biogas described above is temporarily stored in a closed space above the liquid face H. Hereinafter, the closed space above the liquid face H is referred to as a gas storage space 31. In contrast, hereinafter, the space in which the organic waste water W is stored under the liquid face H is referred to as an anaerobic treatment space 33.

In the anaerobic treatment tank 12, the anaerobic treatment of the organic waste water W is performed in the anaerobic treatment space 33, and the biogas is generated. The biogas floats and reaches the liquid face H, and thereby the biogas is temporarily stored in the gas storage space 31. The biogas of the gas storage space 31 is recovered as a useful energy source which is discharged outside through a gas recovery line L6 of a recovery unit 40. The detailed description of the recovery unit 40 will be described later.

Subsequently, a basic operation of an anaerobic treatment method according to the anaerobic treatment system 1 will be described.

Acid Generating Tank Treatment Process

The organic waste water W is introduced with respect to the acid generating tank 11 at the flow rate which is regulated by the regulating tank 9, and the organic material which is included in the organic waste water W is decomposed into the acetic acid or the like by the acid generating bacterium, in the acid generating tank 11. Accordingly, the organic waste water W largely including an organic acid such as the acetic acid is sent to the anaerobic treatment tank 12 from the acid generating tank 11.

Anaerobic Treatment Process

The organic waste water W which is introduced from the inflow unit 13 of the anaerobic treatment tank 12, flows upward within the anaerobic treatment space 33. In this case, the organic waste water W comes in contact with the granular sludge while passing through the granular sludge layer 14, and thereby the organic waste water W is anaerobically treated.

Treated Water Discharge Process

Thereafter, the organic waste water W which reaches the liquid face H overflows into the treated water discharge unit 23 exceeding the upper end of the side wall 18b, and is discharged outside the system through the drain pipe L5 as a treated water. In the treated water which is discharged, the predetermined water treatment is further carried out in the subsequent stage.

### Gas Storage Process

In the anaerobic treatment process described above, the biogas (the methane gas, carbon dioxide or the like) is generated by an anaerobic reaction and floats to the liquid face H, and thereby the biogas is temporarily stored in the gas storage space 31. The biogas which is stored in the gas storage space 31 is recovered by the recovery unit 40.

Next, the configuration of the anaerobic treatment system 1 according to the embodiment of the present invention, will be described in more detail.

The anaerobic treatment system 1 according to the embodiment of the present invention includes the recovery unit 40 that recovers the biogas which is generated in the anaerobic treatment tank 12, a load evaluation unit (state evaluation unit that evaluates the state of the organic waste water) 50 that evaluates the load of the organic waste water W with respect to the anaerobic treatment tank 12, and a heating unit 60 that heats the organic waste water W which flows into the anaerobic treatment tank 12. Furthermore, the anaerobic treatment system 1 includes a control unit 70 that performs various calculations along with executing an operation control of the anaerobic treatment system 1. In the anaerobic treatment system 1 according to the embodiment of the present invention, the organic waste water W is anaerobically treated by the sludge (that is, the anaerobic bacterium in the granular sludge which is acclimated to the low temperature condition) which is acclimated to the low temperature condition within the anaerobic treatment tank 12.

As an anaerobic bacterium, methanogenic bacteria such as “Methanosarcina sp.”, “Methanosaeta sp.”, and “Methanobacterium sp.” are applied. The optimum temperature for the anaerobic bacteria described above is the intermediate temperature, but it is possible to increase the activity even at the low temperature, by acclimating to the low temperature condition. Furthermore, if the temperature of the anaerobic bacterium which is acclimated to the low temperature condition is increased (for example, the intermediate temperature condition is assumed), the activity is increased. In the temperature condition of the anaerobic bacterium, “the low temperature” is the temperature in a range of 10° C. to 25° C., and the temperature in the range of 10° C. to 20° C. is normal. “The intermediate temperature” is the temperature in the range of 30° C. to 40° C., and the temperature in the range of 35° C. to 38° C. is normal. Furthermore, in biological treatments such as an activated sludge method and a methane fermentation method (anaerobic treatment), “acclimating” is maintaining the same activity in the treatment as the related art or obtaining a new throughput, under the conditions such as the waste water which is different hitherto or an environment which is different hitherto. Moreover, by placing a predetermined microbial community under a certain condition or environment, acclimating is making a microbe in the certain condition or environment be a microbe of superior class in place of the microbe of superior class among the microbial community. A general example of acclimating is, for example, making the microbe of which the rate in decomposing or the like is not largely decreased even at the low temperature or the high temperature be the microbe of superior class in place of the microbe of superior class among the microbial community, or maintaining the equivalent rate in the treatment to the related art even in the waste water having the low temperature or the high temperature, when the microbial community such as the activated sludge, which is used to treat the waste water having the intermediate temperature, is adopted to treat the waste water having the low temperature or the high temperature. Additionally, the case that when the waste water containing phenol flows into the microbial community such as the activated sludge which is used to treat the waste water not containing phenol, the state which is not able to decompose the phenol is made at first, but a phenol decomposing bacterium which is included in the microbial community begins to multiply, slowly becomes the microbe of superior class among the microbial community, and can decompose and treat the phenol, is used as a general example of acclimating. In the embodiments according to the present invention, the anaerobic bacterium is acclimated to the low temperature condition. Specifically, for example, with respect to the anaerobic bacterium under the low temperature condition (if the anaerobic bacterium is left to natural changes in the outside air, the low temperature condition is naturally made in winter), by performing the waste water treatment while slowly changing the organic waste water W from the low load to the high load (for example, changing from 3 kg-COD/(m³·d) to 20 kg-COD/(m³·d)) over a predetermined period of time, that is, by performing the control such that first, the load is suppressed to be low, and the load is slowly increased while monitoring the state in acclimating (returned to the state before suppressing the load), the anaerobic bacterium is in the state which is “acclimated to the low temperature condition”.

If the temperature even temporarily is increased, the activity of the anaerobic bacterium which is acclimated to the low temperature condition, can be temporarily increased. Moreover, if the temperature which is temporarily increased is returned to the low temperature condition within a short period of time, the activity returns to the original activity. Here, the “short period of time” is the period of 1 day to 10 days, approximately. The anaerobic treatment system 1 according to the embodiment of the present invention, increases the activity by (temporarily) increasing the temperature when the load of the organic waste water W is (temporarily) increased, even while performing the treatment in the state of reducing the energy by performing the anaerobic treatment with the state of the anaerobic bacterium which is acclimated to the low temperature condition at the normal time, and securely treats the organic waste water W in which the load increased. Furthermore, the load of the organic waste water W is, for example, a volume load (kg-CODcr/(m³·d)), and the amount of the organic material which flows into the anaerobic treatment tank 12 per unit volume, per unit time. When the load of the organic waste water W is increased is relevant to when the concentration of the organic material in the organic waste water W is increased, when own amount of the organic waste water W is increased (even if the concentration is the same), or the like. Moreover, by using an anaerobic treatment system according to the embodiment of the present invention, even if the load of the organic waste water W is increased as 10% to 100% with comparison with the normal time, the stable treatment can performed.

Specifically, the recovery unit 40 is configured by the gas recovery line L6 which is connected to the gas storage space 31 of the anaerobic treatment tank 12, a pump 41 which is arranged in the gas recovery line L6 and the control unit 70 which controls the pump 41. The pump 41 is electrically connected to the control unit 70, and is operated based on a control signal of the control unit 70.

In the embodiment of the present invention, the load evaluation unit 50 performs the evaluation of the load in the organic waste water W based on the amount of the biogas which is recovered by the recovery unit 40. Specifically, the load evaluation unit 50 is configured by a biogas detector 51 as a gas meter which is arranged on the gas recovery line L6 and the control unit 70 that obtains a detection result of the biogas detector 51. The biogas detector 51 is electrically connected to the control unit 70, and sends the detection result to the control unit 70. Here, when the load of the organic waste water W is increased, by increasing the amount of the organic material which is treated within the anaerobic treatment tank 12, the generated amount of the biogas is increased. Therefore, by referring to the detection result of the biogas detector 51, the control unit 70 can evaluate increase and decrease of the load of the organic waste water W. When the amount of the biogas which is detected by the biogas detector 51 is increased, the control unit 70 can evaluate that the load of the organic waste water W is increased. Moreover, when the amount of biogas which is detected by the biogas detector 51 is constant, the control unit 70 can evaluate that the load of the organic waste water W is constant. When the amount of the biogas is decreased, the control unit 70 can evaluate that the load of the organic waste water W is decreased.

The heating unit 60 is configured by a boiler 61 that burns the biogas, a line L7 that distributes a heating medium which is heated in the boiler 61, and a valve 62 that regulates the amount of the heating medium which passes through the line L7.

The boiler 61 burns the biogas into which flows from the line L6, and heats the heating medium. Asa heating medium, for example, water can be used, and by heating, the water as vapor can pass through the line L7. Furthermore, the boiler 61 may include a desulfurizer, a holder that saves the biogas or the like on the upstream side of a combustion unit that burns the biogas. In this case, the pump 41 may not be necessary to be placed depending on specifications of the boiler 61. The boiler 61 is electrically connected to the control unit 70, and the operation thereof is performed based on the control signal of the control unit 70.

The line L7 supplies heating energy to the organic waste water W which flows into the anaerobic treatment tank 12, through the heating medium (vapor) from the boiler 61. Specifically, the line L7 is connected with the upstream side of the anaerobic treatment tank 12, and in the position, the line L7 supplies the heating energy to the organic waste water W through the heating medium. In the example shown in FIG. 1, the line L7 supplies the heating medium to the acid generating tank 11. By directly introducing the heating medium into the organic waste water W, the heating energy may be supplied to the organic waste water W, or by heating the periphery of the tank (or pipe which passes through the tank or the like) by the heating medium, the heating energy may be indirectly supplied to the organic waste water W. The position to which the line L7 supplies the heating energy is not limited to the acid generating tank 11, and the position may be, for example, the regulating tank 9, the line L1 (raw water inflow pipe), the line L2 (water pipe), the line L3 (water pipe) or the like. In addition, the heating energy may be supplied to plural positions. Aline L8 is arranged in the line L7. The line L8 is branched from the line L7 on the further upstream side than the valve 62. The valve 62 is electrically connected to the control unit 70.

By controlling opening and closing of the valve 62, the control unit 70 can regulate the amount of the heating medium which flows through the line L7 and heats the organic waste water W, and the amount of the heat medium which flows through the line L8 and is used for other uses (for example, a manufacturing process other than the waste water treatment or the like). The control unit 70 can increase the heating energy which is supplied to the organic waste water W by opening the valve 62. On the other hand, when the load the organic waste water W is normal, or when the load is lower than normal, the control unit 70 can stop heating in the organic waste water W by closing the valve 62 (or by reducing an opening degree of the valve 62, or by making a non-heating state). Thereby, in the anaerobic treatment tank 12, the treatment of the organic waste water W is performed with the anaerobic bacterium which is acclimated to the low temperature condition. Furthermore, at the time of operating under the environment where the temperature is lower than the low temperature condition in the non-heating state such as a cold district, the control unit 70 may heat the organic waste water W and keep the heat therein so as to maintain the low temperature condition. Additionally, “when the load is normal” is when the load of the organic waste water W which is supplied to the anaerobic treatment system 1 is average.

On the other hand, when it is evaluated that the load of the organic waste water W is increased by the load evaluation unit 50 (when the state evaluation unit determines that heating is necessary), the control unit 70 increases the temperature of the organic waste water W by controlling the boiler 61 and the valve 62. The control unit 70 may heat until the intermediate temperature condition is made. Here, although as not shown, the control unit 70 may control the state so as not to turn to the high temperature by monitoring the temperature. Furthermore, depending on the increase amount of the load, by increasing the temperature of the organic waste water W even without reaching the intermediate temperature condition, the activity of the anaerobic bacterium can be improved. When it is determined that the high state in the load of the organic waste water W is continued, the control unit 70 continues heating in the organic waste water W. When it is evaluated that the load of the organic waste water W returns to the normal time, the control unit 70 stops heating or makes the state of keeping the heat in by decreasing the amount of heating. That is, when heating is not necessary, the control unit 70 may stop heating.

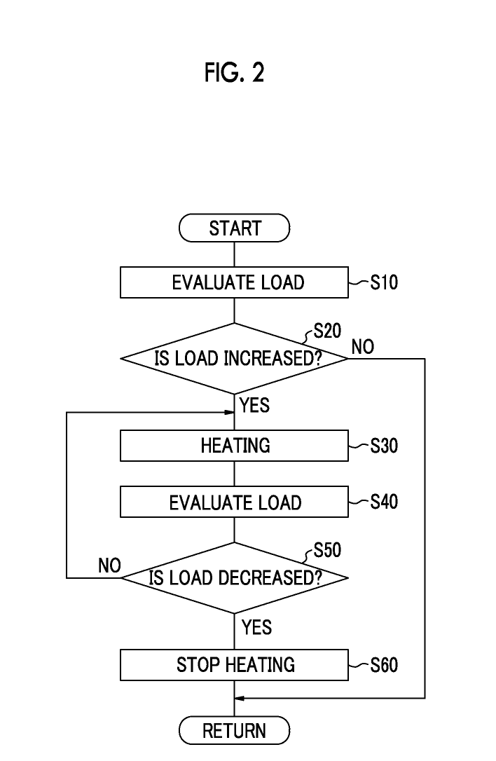

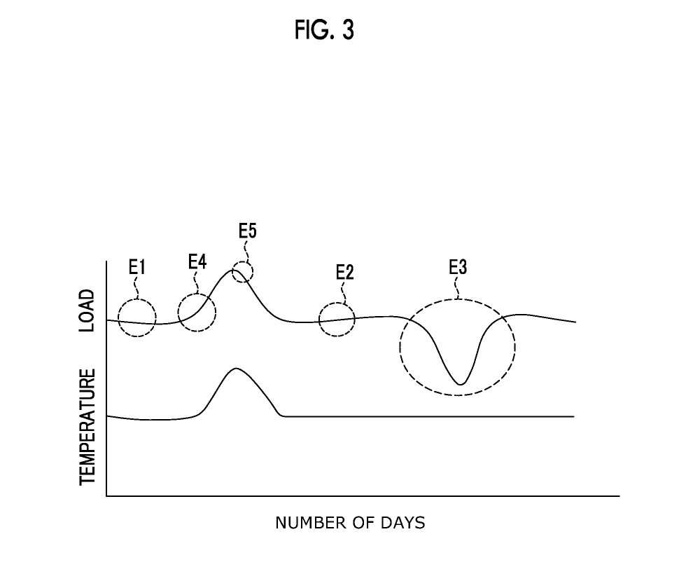

Next, an example of the anaerobic treatment method by the anaerobic treatment system according to the embodiments of the present invention, will be described with reference to FIG. 2 and FIG. 3. FIG. 2 is a flowchart illustrating an example of a flow of a control treatment by the control unit 70. In addition, contents of the control which is shown in FIG. 2 is only an example, and the embodiments of the present invention is not limited to the flowchart.

As shown in FIG. 2, the control unit 70 evaluates the load of the organic waste water W based on the detection result of the biogas detector 51 (step S10, the load evaluation process (state evaluation process)). Based on an evaluation result of S10, the control unit 70 determines whether or not it is evaluated that the load of the organic waste water W is increased (step S20, the load evaluation process (state evaluation process)). In S20, when it is evaluated that the load of the organic waste water W is increased, the control unit 70 does not perform heating of the organic waste water W, and ends the treatment shown in FIG. 2 (or when the heat is kept in the organic waste water W, the state of keeping the heat is continued). Accordingly, by the anaerobic treatment tank 12, the treatment of the organic waste water W is performed by the sludge (anaerobic bacterium) which is acclimated to the low temperature condition (the anaerobic treatment process). Thereafter, the treatment from S10 is started again. As shown in FIG. 3, when the fluctuation of the load occurs, heating is not performed in E1 and E2 of the region having the small fluctuation of the load, and the state of non-heating (or by giving the heat positively, the heat may be kept at a predetermined temperature) is made. Furthermore, even in a region E3 in which the load is decreased, since the activity is not necessary to be increased, the state of non-heating or the state of keeping the heat may be made.

On the other hand, in S20, when it is evaluated that the load of the organic waste water W is increased, the control unit 70 heats the organic waste water W which flows into the anaerobic treatment tank 12 by controlling the heating unit 60 (Step S30, the heating process). For example, as shown in FIG. 3, in a region E4 in which the load is increased, heating is performed by the heating unit 60. Thereby, the temperature of the organic waste water W is increased. In addition, the evaluation method which evaluates that the load of the organic waste water W is increase, is not limited in particular. For example, it may be evaluated that the load is increased at the timing of the amount of the biogas exceeding a predetermined threshold, or it may be determined that the load is increased at the timing of an increase rate of the amount of the biogas exceeding the predetermined threshold. By considering the increase degree of the load or the like, the control unit 70 may control the amount of the heat which is supplied by the heating unit 60. For example, when the load is largely rapidly increased, in order to quickly increase the activity, the amount of the heat which is supplied by the heating unit 60 may be increased. Alternatively, in order to make the operation easy, the control unit 70 may control supplying the constant heat, regardless of the increase degree of the load.

After the treatment of S30, the control unit 70 evaluates the load of the organic waste water W again (step S40). Based on the evaluation result of S40, the control unit 70 determines whether or not it is evaluated that the load of the organic waste water W is decreased (step S50). In S50, when it is not evaluated that the load of the organic waste water W is decreased (for example, when the high load is maintained or when the load is further increased), by returning to S30, heating is continued by the heating unit 60.

On the other hand, in S50, when it is evaluated that the load of the organic waste water W is decreased, the control unit 70 stops heating by the heating unit 60 (step S60). In other words, when it is determined that heating is not necessary, the control unit 70 stops heating which is performed by the heating unit 60. Alternatively, instead of stopping heating by the heating unit 60 immediately, the control unit 70 may control the state so as to finally stop by slowly decreasing the amount of heating. Furthermore, if heating is performed in order to keep the heat in even at the normal time, the amount of heating is decreased to the amount of heating which is necessary in order to keep the heat in. For example, as shown in FIG. 3, in a region E5 in which the decrease of the load is started, heating by the heating unit 60 is stopped, and the temperature is decreased to the temperature according to the low temperature condition at the normal time. In addition, the evaluation method which evaluates that the load of the organic waste water W is decreased, is not limited in particular. For example, it may be evaluated that the load is decreased at the timing of the amount of the biogas decreasing as the predetermined amount than the previous time evaluation or it may be evaluated that the load is decreased at the timing of an decrease rate of the amount of the biogas exceeding the predetermined threshold. By considering the decrease degree of the load or the like, the control unit 70 may control the decrease degree or stop situation of the amount of the heat which is supplied by the heating unit 60. For example, when the load is largely rapidly decreased, heating may be quickly stopped, or when the load is gradually decreased, the amount of heating may be slowly decreased. Alternatively, in order to make the operation easy, the control unit 70 may control the state so as to stop heating immediately (or decrease to the predetermined amount of heating), regardless of the decrease degree of the load. If the treatment of S60 is completed, the treatments in shown in FIG. 2 are completed. Thereafter, the treatment from S10 is started again.

Next, operations and effects of the anaerobic treatment system 1 according to the embodiment of the present invention, will be described.

The anaerobic treatment system 1 according to the embodiment of the present invention, includes the anaerobic treatment tank 12 that anaerobically treats the organic waste water W by the sludge which is acclimated to the low temperature condition. Therefore, when the load of the organic waste water W is stable, the heating energy is not necessary to be supplied (or the low heating energy of the degree in which the heat is kept to the low temperature condition, may be supplied), and it is possible to treat the organic waste water W on the low temperature condition. Thereby, it is possible to reduce the energy. On the other hand, when the load evaluation unit 50 evaluates that the load is increased, the anaerobic treatment system 1 can increase the temperature of the organic waste water W by the heating unit 60. In the sludge which is acclimated to the low temperature condition, if the temperature is temporarily increased, the activity is temporarily increased. Accordingly, only when the load of the organic wastewater W is increased, the temperature of the organic waste water W is increased by the heating unit 60, and then, the activity temporarily is increased. Thereby, even when the load is rapidly increased, the stable treatment can be performed. When the load of the organic waste water W returns to the normal time, by returning to the low temperature condition, the treatment can be performed in the state of reducing the energy. By the above, it is possible to correspond to the rapid increase of the load of the organic waste water W while being able to reduce the energy.

The anaerobic treatment system according to the embodiment of the present invention, further includes the recovery unit 40 that recovers the biogas which is generated in the anaerobic treatment tank 12, and the load evaluation unit 50 may perform the evaluation based on the amount of the biogas which is recovered by the recovery unit 40. Since the generated amount of the biogas is increased or decreased depending on the fluctuation of the load in the organic waste water W, the load evaluation unit 50 can evaluate the load of the organic waste water W based on the amount of the biogas. Thereby, it is possible to exclude the configuration for directly measuring the load of the organic waste water W.

Furthermore, the anaerobic treatment method according to the embodiment of the present invention, includes anaerobically treating the organic waste water W by the sludge which is acclimated to the low temperature condition. Therefore, when the load of the organic waste water W is stable, it is possible to treat the organic waste water W on the low temperature condition. Thereby, it is possible to reduce the energy. On the other hand, when that the load is increased is evaluated in the evaluating, the anaerobic treatment method can increase the temperature of the organic waste water W in the heating. In the sludge which is acclimated to the low temperature condition, if the temperature is temporarily increased, the activity is temporarily increased. Accordingly, when the load of the organic waste water W is increased, the temperature of the organic waste water W is increased by the heating unit 60, and then, the activity is temporarily increased. Thereby, even when the load is rapidly increased, the stable treatment can be performed. By the above, it is possible to correspond to the rapid increase of the load of the organic waste water W while being able to reduce the energy.

The present invention is not limited to the embodiments described above. For example, the configuration of the anaerobic treatment tank is not limited to the configuration described above, and if the configuration is the configuration that can perform the anaerobic treatment, the configuration may be appropriately modified. For example, the anaerobic treatment tank is not limited to the UASB (Upflow Anaerobic Sludge Blanket) reactor, and the anaerobic treatment may be performed using an EGSB (Expanded Granular Sludge Bed) reactor, a carrier or a membrane separation.

Furthermore, in the embodiments described above, the load of the organic waste water W is evaluated based on the amount of the biogas. However, if the method is the method that can evaluate the load of the organic waste water W, all methods may be adopted, and the evaluation may be performed using the detector that directly detects the load of the organic waste water W which flows into the anaerobic treatment tank 12. For example, the detector that directly detects the load of the organic waste water W may be arranged on the further upstream side (for example, the regulating tank 9, the acid generating tank 11, the line L1, the line L2, the line L3 or the like) than the anaerobic treatment tank 12, or the evaluation may be performed based on the amount of the methane.

Moreover, in the embodiments according to the present invention, the case that the load evaluation unit that evaluates the load of the organic waste water W is adopted as an example of “the state evaluation unit” according to the embodiments of the present invention, is described. However, the state evaluation unit may evaluate whether or not heating of the organic waste water W is necessary with respect to all states. In addition, when the state evaluation unit determines that heating is necessary, the anaerobic treatment system may increase the temperature of the organic waste water W by the heating unit. As a condition that the state evaluation unit determines “heating is necessary”, various conditions such as deterioration of the treatment state, the deterioration of water quality in the treated water (organic waste water), the increase of the concentration of the organic material in the treated water, the increase of the concentration of the organic acid (acetic acid, propionic acid or the like) in the treated water, the decrease of the generated amount in the biogas, and the decrease of the generated amount in the methane, may be used.

It should be understood that the invention is not limited to the above-described embodiment, but may be modified into various forms on the basis of the spirit of the invention. Additionally, the modifications are included in the scope of the invention.

What is claimed is:

1. An anaerobic treatment system comprising:
an anaerobic treatment tank that anaerobically treats organic waste water by sludge which is acclimated to a low temperature condition;
a state evaluation unit that evaluates a state of the organic waste water with respect to the anaerobic treatment tank; and
a heating unit that heats the organic waste water which flows into the anaerobic treatment tank,
wherein when the state evaluation unit determines that heating is necessary, a temperature of the organic waste water is increased by the heating unit.

2. The anaerobic treatment system according to claim 1, further comprising:
a recovery unit that recovers biogas which is generated in the anaerobic treatment tank,
wherein the state evaluation unit performs evaluation based on an amount of the biogas which is recovered by the recovery unit.

3. An anaerobic treatment method comprising:
anaerobically treating organic waste water by sludge which is acclimated to a low temperature condition in an anaerobic treatment tank;
evaluating a state of the organic waste water with respect to the anaerobic treatment tank; and
heating the organic waste water which flows into the anaerobic treatment tank,
wherein when that heating is necessary is determined in the evaluating, a temperature of the organic waste water is increased in the heating.
